(19) United States
(12) Patent Application Publication
(10) Pub. No.: US 2023/0241692 A1
(43) Pub. Date: Aug. 3, 2023

(54) MINI POCKET HOLES JIG WITH MOVABLE SCALE FOR WOODWORKERS

(71) Applicant: Yingshen Liu, Qingdao (CN)

(72) Inventor: Yingshen Liu, Qingdao (CN)

(21) Appl. No.: 17/588,379

(22) Filed: Jan. 31, 2022

(51) Int. Cl. B23B 47/28

(52) U.S. Cl. CPC B23B 47/287; B23B 2247/10

(57) ABSTRACT

Disclosed is a mini pocket hole jig for woodworkers with a movable scale, which includes a main body, in which a penetrating inclined hole is machined, a through hole is formed on the right side of the main body, and the through hole is communicated with the inclined hole; sliding grooves are machined on both sides of the main body, and the scale is slidably installed in the sliding grooves on both sides of the main body; the scale is made of a spring steel sheet and marked with scales; due to the elasticity of the material of the scale, the scale can produce damped sliding fit with the sliding grooves on both sides of the main body, and a guide sleeve is installed in the inclined hole; an upper end face of the main body is inclined, the inclined hole is axially perpendicular to the upper end face of the main body, the guide sleeve extends to a side face of the main body, and the end of the guide sleeve is a hexagonal prism; the main body of the mini pocket hole jig is equipped with a movable scale, and when in use, the scale can be reasonably slid according to the thickness of different wood boards for quick measurement and positioning, which is very flexible and improves the efficiency of pocket holes drilling. The mini pocket hole jig is ingenious in design, easy to store, strong in integrity and high in precision of pocket holes drilling.

### TECHNICAL FIELD

The present utility model relates to a mini pocket hole jig with a movable scale for woodworkers.

### BACKGROUND

When carpenters make and decorate furniture, they often use self-tapping nails to connect two boards together. In order to ensure the beauty of the furniture, self-tapping nails usually hit the shade of furniture, which requires pre-drilling pocket holes in one of the boards. In order to ensure the connection strength, the drilling position should be accurate.

At present, several kinds of the pocket hole jigs on the market need to first determine the drilling position according to the thickness of the wood board. The carpenter needs to carry a measuring scale with him. After measurement, he can determine the position of the jig to drill pocket holes, which can't make pocket holes intuitively and quickly. It lacks universality and flexibility, is troublesome to use and operate, and affects work efficiency. Moreover, if the jig's position shifts after measurement, it will cause inaccurate drilling position and affect subsequent assembly.

### SUMMARY

In view of the shortcomings existing in the above problems, the present utility model provides a pocket hole jig with a movable scale for woodworkers.

In order to achieve the above purpose, the present utility model provides a pocket hole jig with a movable scale for woodworkers , which includes:

a main body, in which a through inclined hole is machined, a through hole is opened on a right side of the main body, the through hole is communicated with the inclined hole, and sliding grooves are machined on both sides of the main body;

a scale made of a spring steel sheet, slidably installed in the sliding grooves on both sides of the main body, and marked with scales;

a guide sleeve installed in the inclined hole.

The main body of the pocket hole jig is equipped with a movable scale. When in use, the scale can be reasonably slid according to the thickness of different wood boards for quick measurement and positioning, which is very flexible and improves the efficiency of the pocket hole drilling. The pocket hole jig is ingenious in design, easy to store and strong in integrity.

As a further improvement of the solution, an upper end face of the main body is inclined, and the inclined hole is axially perpendicular to the upper end face of the main body.

In the above technical solution, an inclined plane structure is designed, so that when a user drills a pocket hole, the pocket hole is driven in at an angle perpendicular to the inclined plane, and the use is more convenient.

As a further improvement of the solution, the guide sleeve extends to the side face of the main body, and the outer side of the guide sleeve is in the shape of a regular hexagonal prism.

In the above technical solution, the lengthening of the guide sleeve ensures the quality of pocket holes drilled, and the design of the regular hexagonal prism shape at the outer side of the guide sleeve makes it difficult for the guide sleeve to rotate in the main body of the jig when in use, thus ensuring the drilling accuracy.

Compared with the prior art, the present utility model has the following beneficial effects: the main body of the pocket hole jig is equipped with a movable scale, and when in use, the scale can be reasonably slid according to the thickness of different wooden boards for quick measurement and positioning, which is very flexible and improves the efficiency of pocket holes drilling; the pocket hole jig is ingenious in design, easy to store and strong in integrity; the lengthened guide sleeve ensures the quality of pocket holes drilled.

### BRIEF DESCRIPTION OF DRAWINGS

FIG. 1 is a perspective view of a mini pocket hole jig with a movable scale for woodworkers according to of the present utility model;

FIG. 2 is a perspective view (from the other direction) of the present utility model of a mini pocket hole jig for woodworkers with a movable scale;

FIG. 3 is a perspective view of the guide sleeve of a mini pocket hole jig with a movable scale for woodworkers.

In the figures: 1. Main body; 11. Inclined hole; 12. Sliding groove; 13. Through hole; 2. Guide sleeve; 3. Scale.

### DESCRIPTION OF EMBODIMENTS

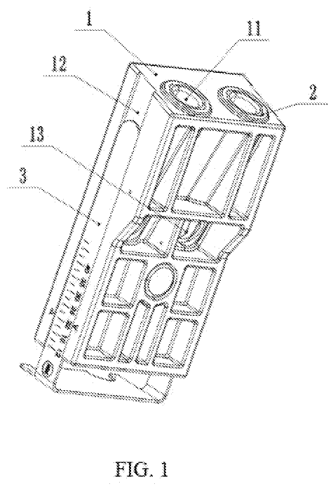

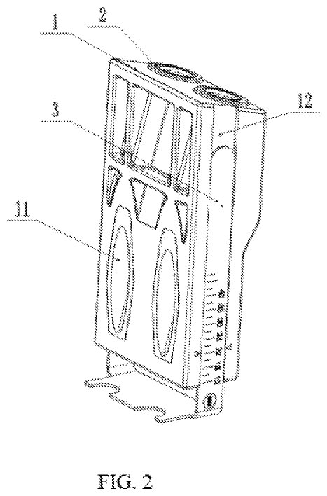

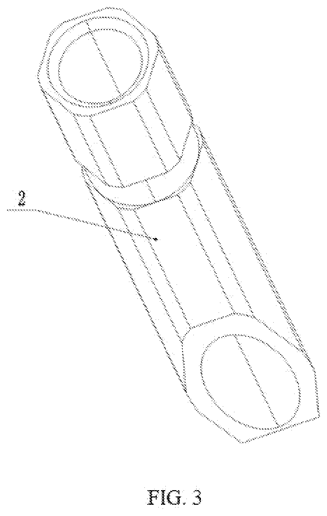

As shown in FIG. 1 and FIG. 2, a mini pocket hole jig with a movable scale for woodworkers in this embodiment of the present utility model comprises a main body 1, in which a penetrating inclined hole 11 is machined, and a through hole 13 is opened on the right side of the main body 1, which is communicated with the inclined hole 11, and sliding grooves 12 are machined on both sides of the main body 1; the scale 3 is made of a spring steel sheet, which can be slidably installed in the sliding grooves 12 on both sides of the main body 1, and the scale 3 is marked with scales; a guide sleeve 2 is installed in the inclined hole 11; wherein, an upper end face of the main body 1 is an inclined plane, and the inclined hole 11 is axially perpendicular to the upper end face of the main body and is designed to be an inclined plane structure, so that when the user drills the pocket hole, the pocket hole is driven in at an angle perpendicular to the inclined plane, and the use is more convenient; the guide sleeve 2 extends to the side face of the main body 1, and the lengthening of the guide sleeve ensures the quality of the pocket holes drilled. The outer side of the guide sleeve 2 is in a regular hexagonal prism shape (see FIG. 3). The design of the regular hexagonal prism shape on the outer side of the guide sleeve makes it difficult for the guide sleeve to rotate in the main body of the jig when in use, thus ensuring the quality of the pocket holes drilled.

The main body of the mini pocket hole jig is equipped with a movable scale, which is made of a spring steel sheet. The scale can be in damped sliding fit with the sliding groove. When in use, the scale can be reasonably slid according to the thickness of different wood boards to quickly measure and locate, which is very flexible and improves the efficiency of pocket holes drilling. The mini pocket hole jig is ingenious in design, easy to store and strong in integrity. The lengthened guide sleeve ensures the quality of the pocket holes drilled.

The above description is only the preferred embodiment of the present utility model, and is not used to limit the present utility model. For those skilled in the field, the present utility model can be modified and changed in various ways. Any modification, equivalent replacement, improvement and the like made within the spirit and principle of the present utility model shall fall within the protection scope of the present utility model.

What is claimed is:

1. A mini pocket hole jig with a movable scale for woodworkers, comprising:
a main body (1), in which a through inclined hole (11) is machined, a through hole (13) is opened on a right side of the main body (1), the through hole (13) is communicated with the inclined hole (11), and sliding grooves (12) are machined on both sides of the main body (1);
a scale (3) made of a spring steel sheet, slidably installed in the sliding grooves (12) on both sides of the main body (1), and marked with scales;
a guide sleeve (2) installed in the inclined hole (11).

2. The mini pocket hole jig with a movable scale for woodworkers according to claim 1, wherein an upper end face of the main body (1) is inclined, and the inclined hole (11) is axially perpendicular to the upper end face of the main body (1).

3. The mini pocket hole jig for woodworkers with a movable scale according to claim 1, wherein the guide sleeve (2) extends to the side of the main body (1), and the outer side of the guide sleeve (2) is in the shape of a regular hexagonal prism.
